(19) United States
(12) Patent Application Publication
(10) Pub. No.: US 2019/0212994 A1
(43) Pub. Date: Jul. 11, 2019

(54) AUTOMATION OF SQL STATEMENT & RELATED SOURCE CODE TRANSFORMATION

(71) Applicant: SimpleDelta ApS, Copenhagen (DK)

(72) Inventor: Martin Spiegelhauer, Copenhagen (DK)

(21) Appl. No.: 16/353,095

(22) Filed: Mar. 14, 2019

Related U.S. Application Data
(63) Continuation of application No. 16/245,432, filed on Jan. 11, 2019.
(60) Provisional application No. 62/616,008, filed on Jan. 11, 2018.

(51) Int. Cl. G06F 8/51; G06F 8/75

(52) U.S. Cl. CPC G06F 8/51; G06F 8/75

(57) ABSTRACT

A system for transforming source code, the system comprising a processor, and a memory having executable instructions stored thereon including an application framework comprising a code analysis and execution engine, the code analysis and execution engine comprising source code that include queries to a database server, wherein the code analysis and execution engine executes a code transformation program, the code transformation program including instructions that when executed by a processor causes the processor to analyze a scope of one or more programs, retrieve the one or more from a source code repository, transform the one or more programs according to a given syntax, and save the transformed one or more programs to the source code repository.

### CROSS REFERENCE TO RELATED APPLICATION

This application claims the priority of U.S. Provisional Application No. 62/616,008, entitled “AUTOMATION OF SQL STATEMENT & RELATED SOURCE CODE TRANSFORMATION,” filed on Jan. 11, 2018, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to applying changes to a code base, and in particular, the remediation or transformation of data query language to conform to a change in an underlying database.

### Description of the Related Art

Given an application, connected to a structured data collection, such as a database, when upgrading/changing the database, functional behavior and performance can change due to the code of the application being written for the existing database rather than the new database. Upgrading the underlying database of an application can therefore create a multitude of issues. More specifically, these issues can be categorized into the following categories, but are not limited to: 1) A database that has an assumed implicit sort for each select. If the application does not explicitly sort, functional errors can occur due to an order of data that can no longer be assumed. 2) A database that changes from row-based to columnar-based. This can create performance issues given the nature of columnar-based data retrieval.

An example of a scenario as specified above includes when upgrading/changing the underlying database of, for example, an SAP® enterprise application system from a row based-database, such as Oracle® Database, to a columnar based-database, such as a SAP HANA® database. The custom code base may need to be adapted to become “compliant” with the new database to avoid functional and performance related issues post upgrade/change.

### SUMMARY OF THE INVENTION

The present invention provides a system for transforming source code. According to one embodiment, the system comprises a processor and a memory having executable instructions stored thereon including an application framework comprising a code analysis and execution engine, the code analysis and execution engine comprising source code that include queries to a database server, wherein the code analysis and execution engine executes a code transformation program, the code transformation program including instructions that when executed by a processor causes the processor to analyze a scope of one or more programs, retrieve the one or more programs from a source code repository, transform the one or more programs according to a given syntax, and save the transformed one or more programs to the source code repository.

The given syntax may include specifying sorting in the queries. In another embodiment the given syntax may include specifying nameless source fields in the queries. In yet another embodiment, the given syntax may include specifying a full key definition.

### BRIEF DESCRIPTION OF THE DRAWINGS

The invention is illustrated in the figures of the accompanying drawings which are meant to be exemplary and not limiting, in which like references are intended to refer to like or corresponding parts.

FIGS. 1-6 illustrate computing systems according to various embodiments of the present invention.

FIG. 7 illustrates a flowchart of a method for transforming source code according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The disclosed systems provide for remediation/transformation of custom code base including queries written in structured query language (such as “SQL” or “OpenSQL”, but not limited to) to adapt to a change in an underlying database that has an implicit sort for each select and/or a database that is changed from row-based to columnar-based. For example, a specific sorting may be added to relevant queries. Fields may also be defined for queries making use of ‘*’ instead of named fields. Queries returning only one entry as a result by request (such as when using “Select Single”), but not defined by a full primary key of a query table in question, may return the same one entry as a result as before the upgrade/change by not only adding explicit sorting to the query, but by changing the query from a “Select Single” Construct to a “Select/Endselect” construct making use of “Up to 1 Rows” and “Order By” additions, according to embodiments of the present disclosure.

According to one embodiment, a SQL “Select *” may be implemented without specifying source field(s). When querying a database table using the “Select *” syntax, it's possible not to specify source fields in the table structure and thereby get the entire structure of all fields in the table returned in the result set. An example of such a statement could look like the following:

Select * from VBAP into table LT_VBAP

where VBELN=‘1234567890’.

Should only two fields of the table structure be needed in the result set, the statement could be modified accordingly for performance improvement, such as the following:

Select VBELN POSNR from VBAP into corresponding fields of table LT_VBAP

where VBELN=‘1234567890’.

This change in statement construct may, especially in a columnar database table, result a significant performance improvement.

When retrieving data from a database table, the data returned in the result set can be returned in either a sorted or non-sorted way. Source code that is based on the behavior of an existing database might not function as expected when upgrading/changing the database and might behave differently if not sorting the result set before returning it after upgrading/changing the database. As such, according to another embodiment, a SQL “Select” may be implemented that assumes a sorted result set. An example of such a statement could look like the following:

Select VBELN POSNR from VBAP into corresponding fields of table LT_VBAP

where VBELN=‘1234567890’.

The correct way to mitigate for the risk of data not being sorted in the order expected is to define an explicit sort for the result set:

Select VBELN POSNR from VBAP into corresponding fields of table LT_VBAP

where VBELN=‘1234567890’ order by primary key.

This change in statement construct can impact the sorting of the result set within a database with parallel processing of SQL Select.

When retrieving data from a database table, where a single record is requested, using the “Select Single” syntax, the data returned in the result set may be read/retrieved in either a sorted or non-sorted way. Given that “Select Single” returns only one result, the correct way of requesting this one result is by providing a full, non-ambivalent key to the result expected. Should an ambivalent request be made where a full key guaranteeing uniqueness is not specified, such as using the primary key of a table, the database may return the first occurring result satisfying the request. Should the database make use of parallelization of work processes, several results can be found by several parallel processes and no longer guarantees that the same result will be returned as if a sequential processing mode had been used.

TABLE 1

| VBELN(Primary Key | POSNR(Primary Key | |
|---|---|---|
| Field) | Field) | POSAR |
| 1000000001 | 00010 | A |
| 1000000001 | 00020 | B |
| 1000000002 | 00010 | C |
| 1000000002 | 00020 | D |
| 1000000002 | 00030 | E |

For example, referring to Table 1, in a database using sequential/non-parallelized processing, the following SQL request may return the first occurrence when searching the database table for a match for the request:

Select single POSAR from VBAP into LV_POSAR

where POSNR=‘00020’.

The result of this statement would be that LV_POSAR would be equal to ‘B’ (VBELN=‘1000000001’ and POSNR=‘00020’).

Should the database use parallelized processing the result could have been LV_POSAR would be equal to ‘D’ (VBELN=‘1000000002’ and POSNR=‘00020’) and not as expected, based on existing database behavior, LV_POSAR=‘B’ (VBELN=‘1000000001’ and POSNR=‘00020’).

According to yet another embodiment, a way to mitigate for the risk of data not being sorted in the order expected is to define the full key, guaranteeing uniqueness to the result, such as the following:

Select POSAR from VBAP into LV_POSAR up to 1 rows

where POSNR=‘00020’ order by primary key.

Endselect.

If this cannot be achieved due to program logic, the database may be forced into using sequential processing and then use the first result satisfying the given request. This change in statement construct can guarantee a sequential read given the ambivalence of the request.

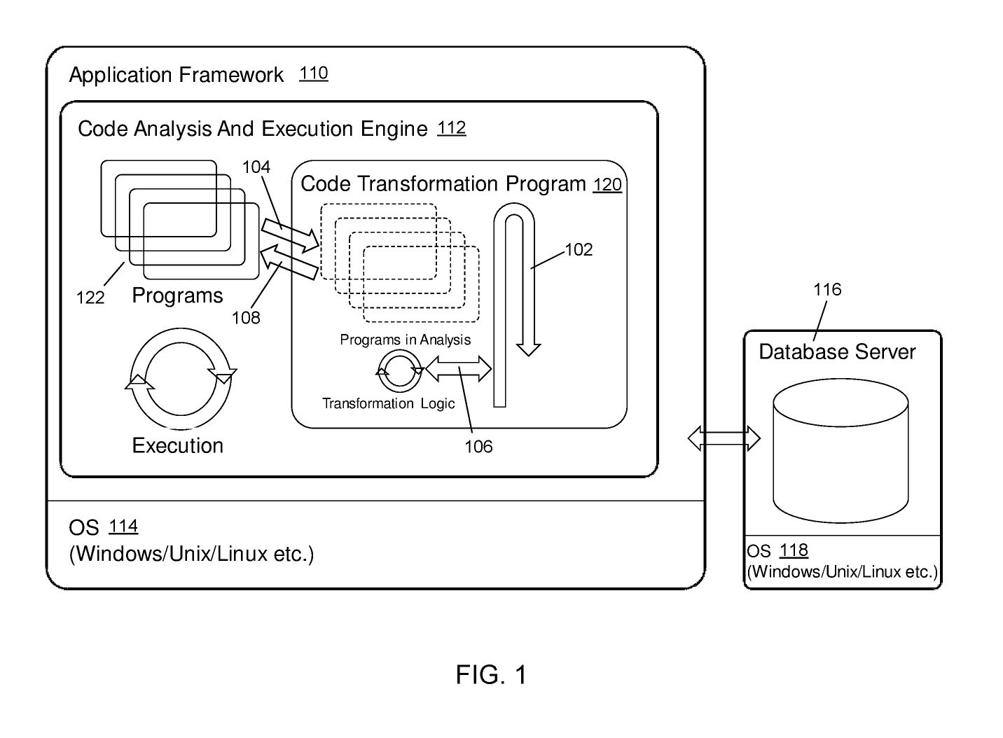

Referring to FIG. 1, code analysis and execution engine 112 may be contained within application framework 110. The application framework 110 may operate within an OS (operating system) 114 executed by a computing device. The application framework 110 may establish a database connection between the computing device and database server 116. The database server 116 may include a processor and memory running an OS 118. Code analysis and execution engine 112 includes code transformation program 120. Code transformation program 120 may analyze the scope of programs 122 and loop over the programs 102 identified by analysis. Programs 122 may comprise source code from a source code repository. The source code may include query statements directed to database server 116. The programs 122 can be retrieved by get program 104 for transformation by process program 106 that applies transformation logic according to the exemplary syntax discussed above. The transformed program/source code may be saved back to the source code repository by save program 108.

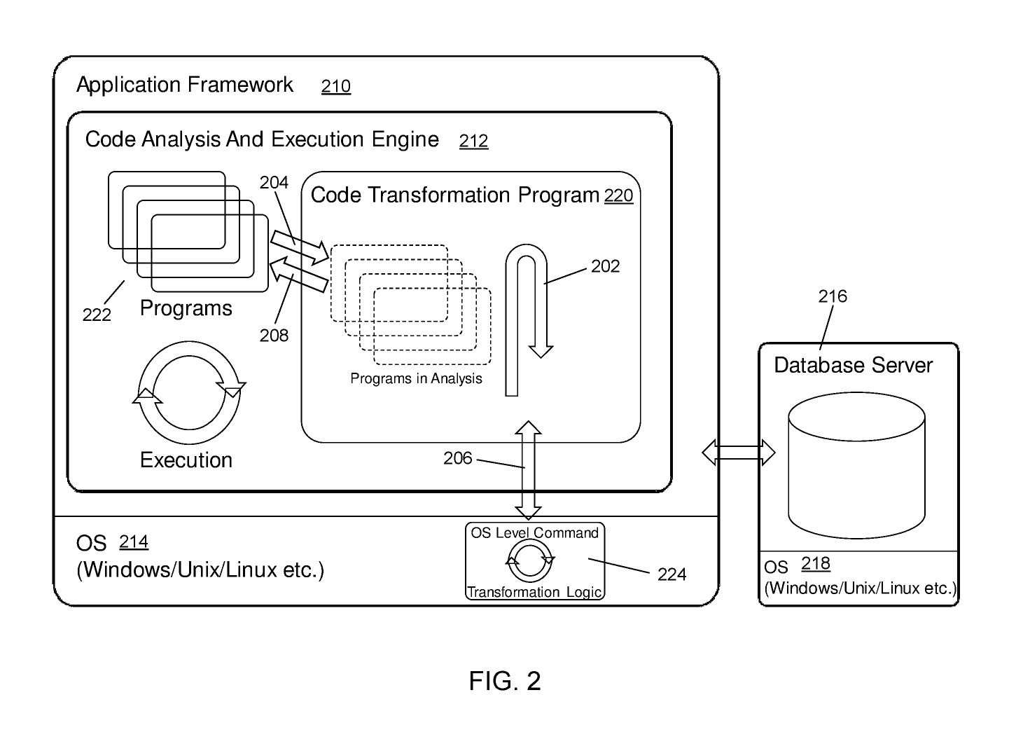

FIG. 2 presents a computing system for transforming source code via an external command or application according to one embodiment. Code analysis and execution engine 212 may be contained within application framework 210. The application framework 210 may operate within an OS 214 executed by a computing device. The application framework 210 may establish a database connection between the computing device and database server 216. The database server 216 may include a processor and memory running an OS 218. External command or application 224 may comprise executable application running on the OS 214 level outside the application framework 210 itself but is executable from within the application framework 210. Code transformation program 220 may analyze the scope of programs 222 and loop over the programs 202 identified by analysis. Programs 222 may comprise source code from a source code repository. The source code may include query statements directed to database server 216. The programs 222 can be retrieved by get program 204 for transformation by process program 206 executed via external command or application 224 that applies transformation logic according to the exemplary syntax discussed above. The transformed program/source code may be saved back to the source code repository by save program 208.

In other embodiments, the disclosed system may be implemented in a combination of a file-based client/server application including an application framework custom application (client or server) that extracts relevant data to one or more files (data containers or their likes) and an external application (client or server) that can ingest these extract files, execute the remediation/transformation and generate a result that then can be imported back into the main application framework. The different applications/components can all run on the same machine or separate machines.

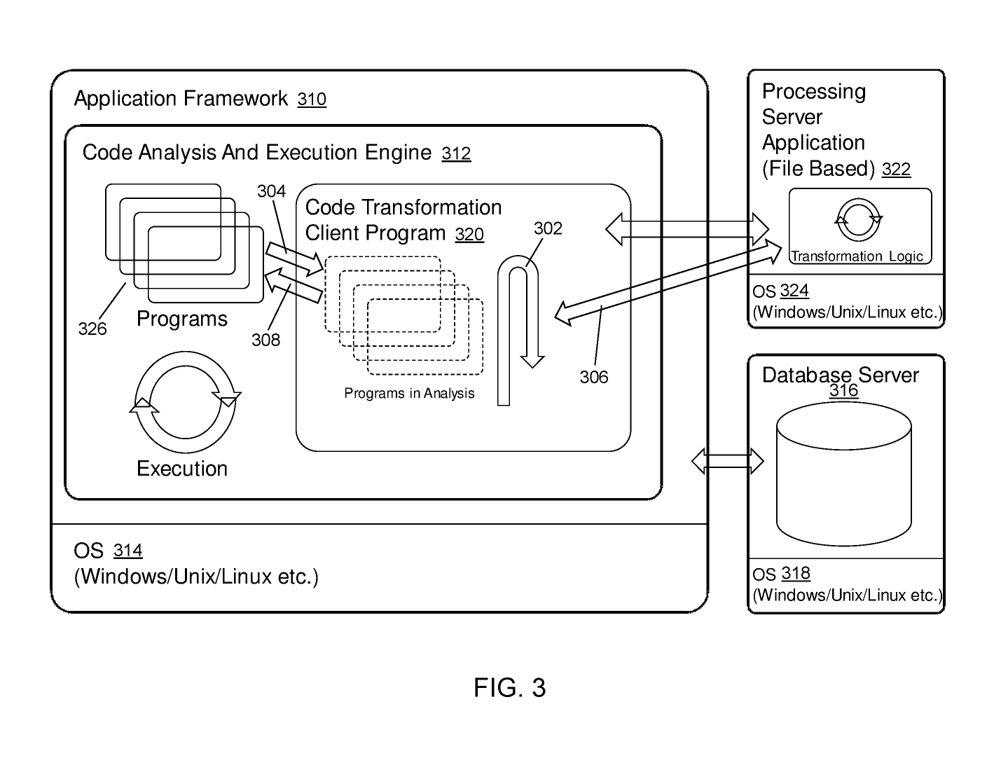

Referring to FIG. 3, code transformation client program 320 runs within the main application framework 310 and the processing server application 322 runs outside of the main application framework 310. The processing server application (file-based) 322 may be executed on a computing device that runs an OS 324 and has a file connection with code transformation client program 320. The application framework 310 may operate within an OS 314 executed by a computing device. The application framework 310 may establish a database connection between the computing device and database server 316. The database server 316 may include a processor and memory running an OS 318. Code transformation client program 320 may analyze the scope of programs 326 and loop over the programs 302 identified by analysis. Programs 326 may comprise source code from a source code repository. The source code may include query statements directed to database server 316. The programs 326 can be retrieved by get program 304 for transformation by process program 306 executed via processing server application 322 that applies logic according to the exemplary syntax discussed above. The transformed program/source code may be saved back to the source code repository by save program 308.

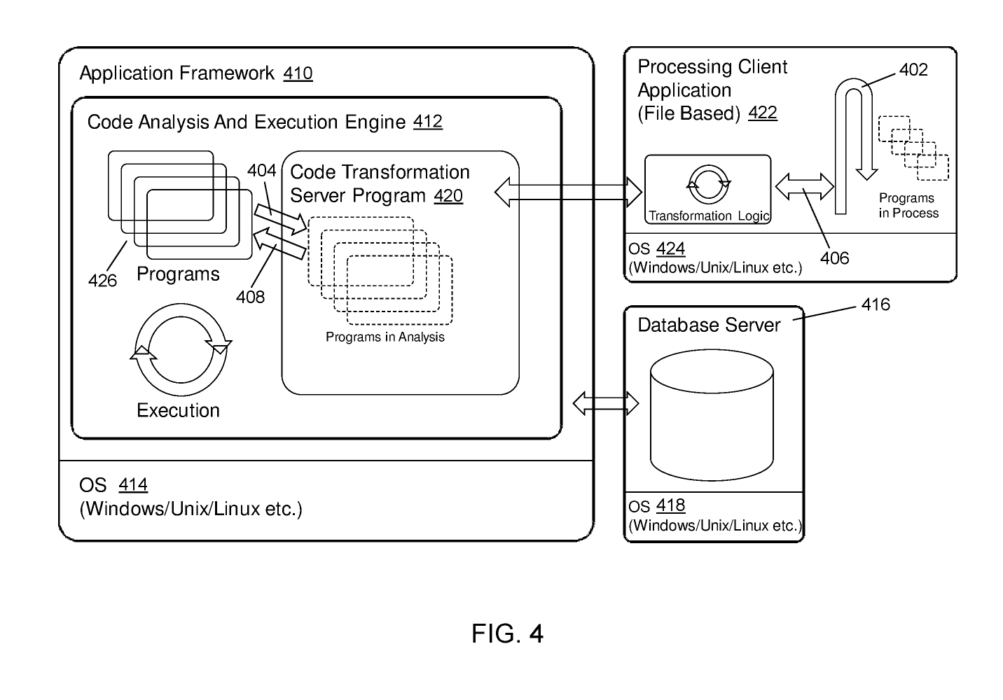

Referring to FIG. 4, code transformation server program 420 may run within the application framework 410 and the processing client application 422 may run outside of the main application framework 410. The processing client application (file-based) 422 may be executed on a computing device that runs an OS 424 and has a file connection with code transformation server program 420. The application framework 410 may operate within an OS 414 executed by a computing device. The application framework 410 may establish a database connection between the computing device and database server 416. The database server 416 may include a processor and memory running an OS 418. Code transformation server program 420 may analyze the scope of programs 426 and communicate with processing client application 422 to loop over the programs 402 identified by analysis. Programs 426 may comprise source code from a source code repository. The source code may include query statements directed to database server 416. The programs 426 can be retrieved by get program 404 for transformation by process program 406 executed via processing client application 422 that applies logic according to the exemplary syntax discussed above. The transformed program/source code may be saved back to the source code repository by save program 408.

The disclosed system may be further configured as external service-based client/server applications in additional embodiments. Such systems may include an application framework custom application (client or server) that communicates with an external application (client or server) that executes the entire or partial remediation/transformation and then return the remediated/transformed custom code back into the application framework. The different applications/components can all run on the same machine or separate machines.

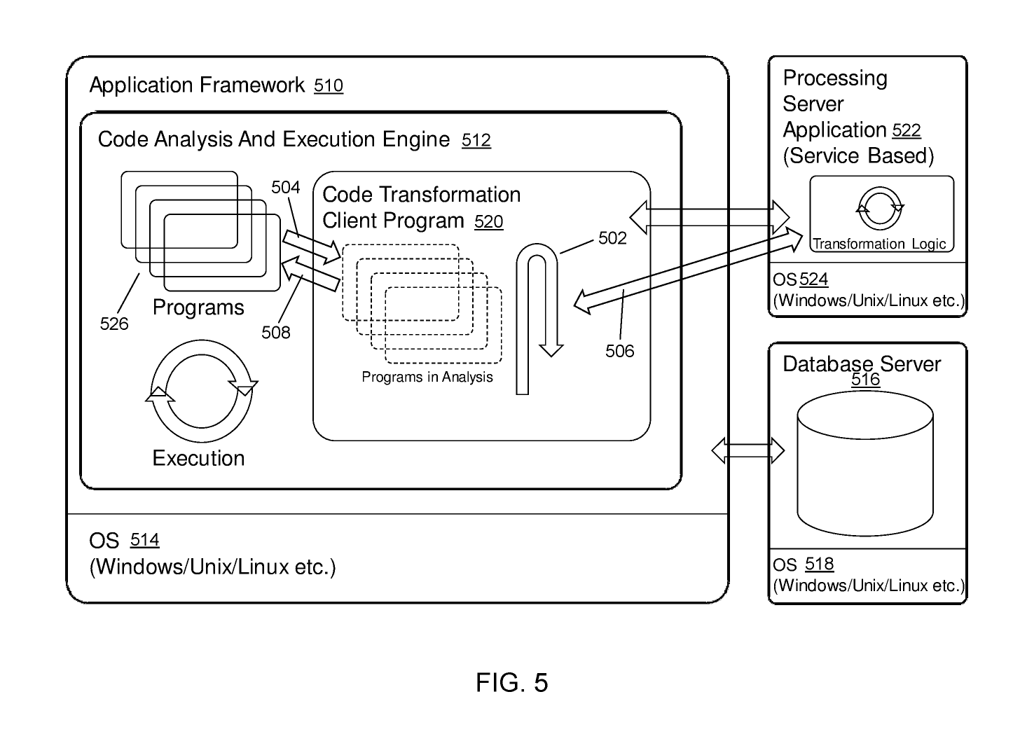

FIG. 5 presents a service-based server application system including a code transformation client program 520 running within the main application framework 510 and the processing server application 522 running outside of the main application framework 510. The processing server application (service-based) 522 may be executed on a computing device that runs an OS 524 and has a service connection with code transformation client program 520. The application framework 510 may operate within an OS 514 executed by a computing device. The application framework 510 may establish a database connection between the computing device and database server 516. The database server 516 may include a processor and memory running an OS 518. Code transformation client program 520 may analyze the scope of programs 526 and loop over the programs 502 identified by analysis. Programs 526 may comprise source code from a source code repository. The source code may include query statements directed to database server 516. The programs 526 can be retrieved by get program 504 for transformation by process program 506 executed via processing server application 522 that applies logic according to the exemplary syntax discussed above. The transformed program/source code may be saved back to the source code repository by save program 508.

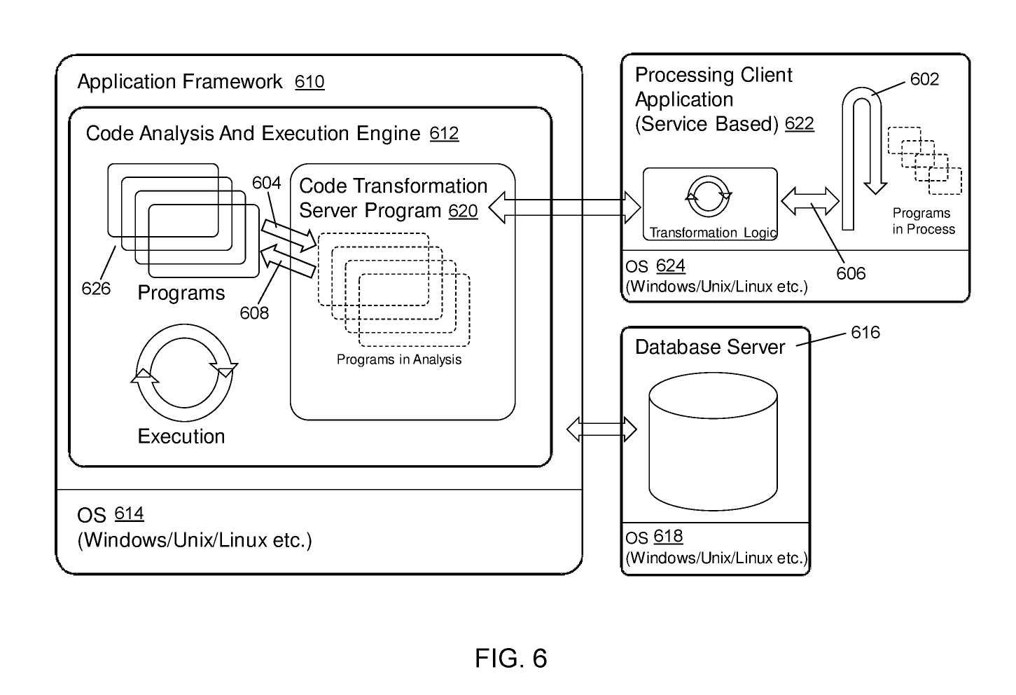

FIG. 6 presents a scenario where code transformation server program 620 runs within the main application framework 610 and a processing client application 622 runs outside of the main application framework 610. The processing client application 622 may be executed on a computing device that runs an OS 624 and has a service connection with code transformation server program 620. The application framework 610 may operate within an OS 614 executed by a computing device. The application framework 610 may establish a database connection between the computing device and database server 616. The database server 616 may include a processor and memory running an OS 618. Code transformation server program 620 may analyze the scope of programs 626 and communicate with processing client application 622 to loop over the programs 602 identified by analysis. Programs 626 may comprise source code from a source code repository. The source code may include query statements directed to database server 616. The programs 626 can be retrieved by get program 604 for transformation by process program 606 executed via processing client application 622 that applies logic according to the exemplary syntax discussed above. The transformed program/source code may be saved back to the source code repository by save program 608.

The data itself being exchanged between the components of the disclosed systems include 1) source code to be transformed, 2) metadata describing the actual issue to be transformed, and 3) control data regarding the processing itself (e.g., success/error indicators, descriptions, specifics, etc.). The metadata may contain all details of the specifics of the issue, the construct/break down of the statement in question and data to be used for the actual transformation. Apart from metadata pertaining to the actual issue and the specifics thereof, control data is also exchanged.

Client devices may comprise computing devices (e.g., desktop computers, terminals, laptops, personal digital assistants (PDA), cellular phones, smartphones, tablet computers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features. A client device may include or execute a variety of operating systems, including a personal computer operating system, such as a Windows, Mac OS, Unix or Linux, or a mobile operating system, such as iOS, Android, or Windows Phone, or the like. A client device may include or may execute a variety of possible applications, such as a client software application enabling communication with other devices.

Communications between clients, servers, components and other devices may be transported over one or more computing networks. A network may be any suitable type of network allowing transport of data communications across thereof. The network may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments.

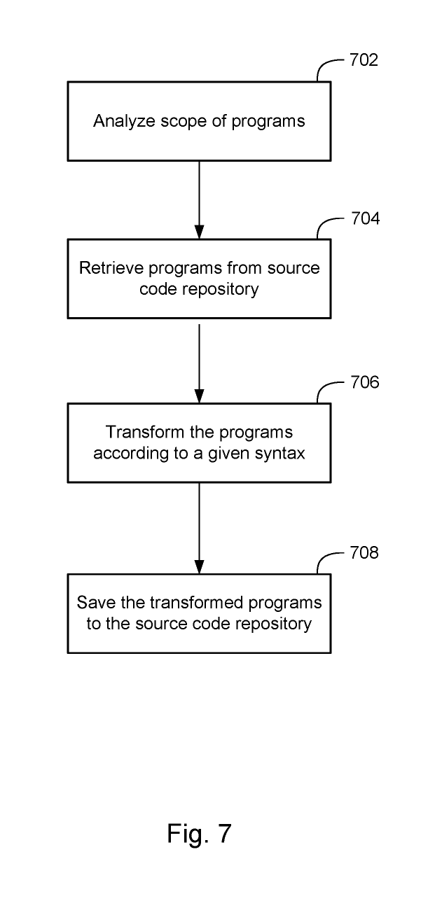

FIG. 7 presents a flowchart of an example of a method for transforming source code according to an embodiment of the present invention.

A scope of a plurality of programs is analyzed, step 702. The plurality of program codes may comprise source code that is stored in a code repository of an application framework. The program codes may be accessible by a code transformation program for analysis where the programs identified by analysis may be looped over.

The plurality of programs are retrieved from a source code repository, step 704. The programs can be retrieved by a get program/functionality for transformation. The plurality of programs are transformed according to a given syntax, step 706. A process program may apply logic according to a given syntax, such as queries with explicit sorting, nameless source fields, and full key definitions. The transformed programs are saved to the source code repository, step 708. The transformed program/source code may be saved back to the source code repository by a save program/functionality.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for transforming source code, the system comprising:
a processor; and
a memory having executable instructions stored thereon including an application framework comprising a code analysis and execution engine,
the code analysis and execution engine comprising source code that include queries to a database server,
wherein the code analysis and execution engine executes a code transformation program, the code transformation program including instructions that when executed by a processor causes the processor to:
analyze a scope of one or more programs,
retrieve the one or more programs from a source code repository,
transform the one or more programs according to a given syntax, and
save the transformed one or more programs to the source code repository.

2. The system of claim 1 wherein the given syntax includes specifying explicit sorting in the queries.

3. The system of claim 1 wherein the given syntax includes specifying nameless source fields in the queries.

4. The system of claim 1 wherein the given syntax includes specifying a full key definition.
